(19) United States
(12) Patent Application Publication
(10) Pub. No.: US 2010/0057826 A1
(43) Pub. Date: Mar. 4, 2010

(54) Distributed Workflow Process Over a Network

(76) Inventors: Weihsiung William Chow, Cerritos, CA (US); Michael Constantin, Irvine, CA (US)

Correspondence Address: MICHAEL BLAINE BROOKS, PC, P.O. BOX 1630, SIMI VALLEY, CA, 93062-1630, US

(21) Appl. No.: 12/202,055

(22) Filed: Aug. 29, 2008

(51) Int. Cl. G06F 15/16

(52) U.S. Cl. 709/201

(57) ABSTRACT

Systems, methods, and computer-readable media for executing workflow in a distributed network of computing devices via one or more proxy workflow components and a communication protocol enabled device-specific execution of particular workflow components while fully supporting the execution of a complete workflow from an originating device.

### FIELD OF ENDEAVOR

The present invention in its several embodiments relates generally to distributed workflow architecture, and more particularly to distributed execution of workflow components via proxy workflow components.

### BACKGROUND

A workflow automation product supports both communal generation and communal control of an end product or work piece such as a completed document. For example, a workflow automation product allows users to create a workflow model and components, such as online forms, and then these users or other users exercise the workflow automation product in order to manage and/or enforce the consistent handling of the work piece. A workflow engine is a development tool by which one or more processes may be captured as workflow components in a workflow automation program that comprises the procedures, the steps of each procedure, and the rules for each step.

Generally, a workflow component is a reusable software module. Accordingly, reusable software modules may be packaged as workflow components where each workflow component provides some property settings in order to allow the workflow authors flexibility to customize the workflow component. A workflow framework provides a mechanism to configure a workflow. Typically, all workflow components are executed by the same machine, within a workflow host, in order to share information or to readily manage flow control. The workflow components may be implemented in a programming language in conjunction with libraries and interfaces that capture abstraction for task coordination. An example of such libraries and interfaces is MICROSOFT™ WINDOWS™ Workflow Foundation.

Workflow as a term used in the present specification refers to a machine-enabled process that executes a configured set of reusable software modules. Having all workflow components hosted in one machine and run within the same processing host presents some issues as described below. For example, software licenses of special software may be tied to a specific machine or class of machines, e.g., servers, none of which are the machine that started the workflow. Similarly, data required at a step or phase of the workflow may be accessed exclusively by a machine different from the machine that started the workflow. Also, a user may be required to interact with a workflow component via a specific machine different from the machine that starts the workflow.

### SUMMARY

Systems, methods, and computer-readable media for executing workflow in a distributed network of computing devices via one or more proxy workflow components and a communication protocol enable device-specific execution of particular workflow components while supporting the execution of a complete workflow from an originating device. For example, some embodiments include a computing device having a processing unit and addressable memory, where the processing unit is adapted or configured to execute, by loading the host workflow, one or more instructions of a proxy workflow component based on a configuration file and a set of one or more property values. The processing unit may be further adapted or configured to generate a communication for a second, or remote, computing device. A communication that initializes a remote execution of one more workflow components may comprise a configuration file name and a set of one or more property values for a workflow component related to the proxy workflow component. In some embodiments, the processing unit of a computing device, such as a remote device, may be adapted or configured to execute one or more instructions of a workflow component based on an identified configuration file provided by a source, e.g., the originating computing device, and a set of one or more property values provided by the source, and the processing unit of the remote device may be further adapted or configured to generate, for the source, a set of results of the execution of the one or more workflow components by the remote device. In addition, the processing unit of the remote device may be further adapted or configured to generate the set of results as input for a workflow component of the source following the proxy workflow component most recently addressed at the source.

Embodiments of the present invention also include machine-enabled methods of distributed workflow processing within a computer network that includes, not necessarily in the following order, the steps of: (a) providing a proxy workflow component associated with a configuration file at a first computing node or first computing device; (b) providing a workflow component associated with the configuration file at a second computing node, or second computing device; (c) preparing a transmission at the first computing node based on the proxy workflow component where the transmission comprises the configuration file name and a set of input values; (d) executing the workflow component, at a second computing node or computing device, with one or more members of the set of input values based on a receipt of the transmission from the first computing node; and (e) preparing a response to the transmission, by the second computing node, comprising the configuration file name and a set of output values based on the workflow component executed by the second computing node.

Embodiments of the present invention include a computer-readable medium having computer-executable instructions stored thereon which, when executed by a computer, are operative to cause the computer to: (a) perform the one or more instructions of a proxy workflow component based on a configuration file having a set of one or more property values; and (b) generate a communication for the second computing device, the communication comprising the configuration file name and one or more members of the set of one or more property values for a workflow component related to the proxy workflow component.

### BRIEF DESCRIPTION OF THE DRAWINGS

Embodiments of the present invention are illustrated by way of example and not limitation in the figures of the accompanying drawings, and in which:

FIG. 1 illustrates a distributed network of computing devices according to embodiments of the present invention;

FIG. 2 is a graphical depiction of an exemplary proxy component according to embodiments of the present invention;

FIG. 3 is a graphical depiction of an exemplary communication protocol according to embodiments of the present invention;

FIG. 4A is a functional block process diagram of an exemplary embodiment of the present invention;

FIG. 4B is a functional block process diagram of an exemplary embodiment of the present invention; and

FIG. 5 is a process diagram of an exemplary embodiment of the present invention.

### DETAILED DESCRIPTION

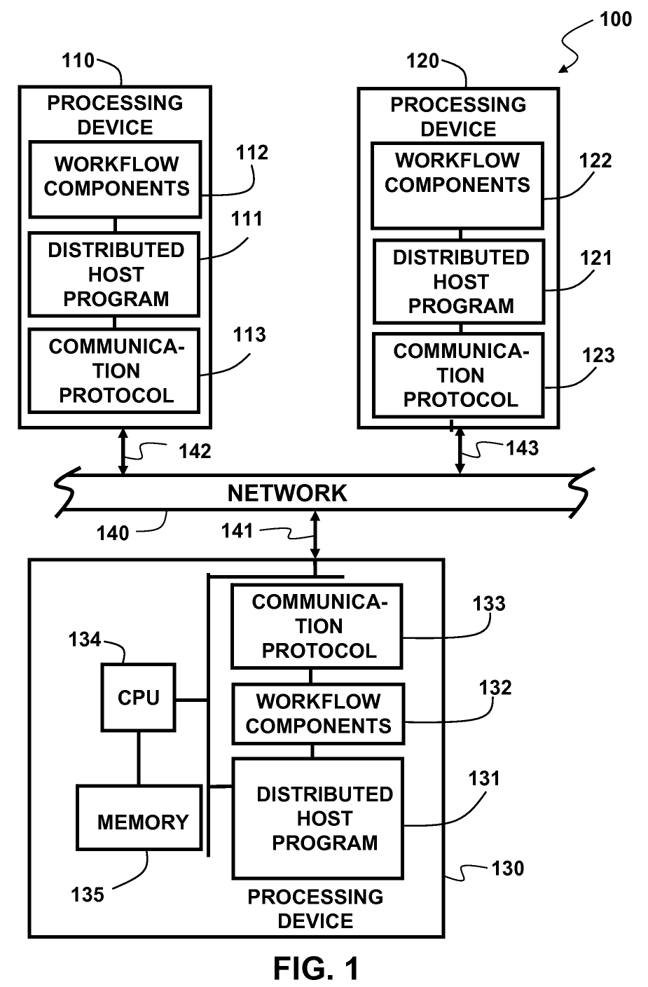

FIG. 1 illustrates in a distributed network of computing devices 100 that each processing device 110, 120, 130 comprise a respective distributed host program 111, 121, 131, a respective set of workflow components 112, 122, 132, and rules for a communication protocol 113, 123, 133. A host application program includes an application program that executes as a machine-enable process under the control of the operating system in a computer having a central processing unit (CPU) 134 and addressable memory 135. The host application may be loaded onto computer-readable media such as a mass storage device, e.g., a hard drive. Although the description of computer-readable media contained herein refers to a mass storage device, such as a hard disk or CD-ROM drive, it should be appreciated by those skilled in the art that computer-readable media can be any available media that can be accessed by the computer. Workflow components 112, 122, 133 may be reusable software modules that are packaged as a Dynamic-Link Library (DLL). In some embodiments, the reusable software modules are only loaded to memory when needed and then bound together as a runtime machine executable process. Each processing device 110, 120, 130 is illustrated as having a network link 141, 142, 143 by which internetworking may be established via a network 140 or a communication bus. Each network link 141, 142, 143 may be a cable, a wireless link or means of establishing operable communication within the network 140 and optionally across networks. A network element 140 or bus may not be present in some peer-to-peer embodiments of the distributed network of computing devices 100.

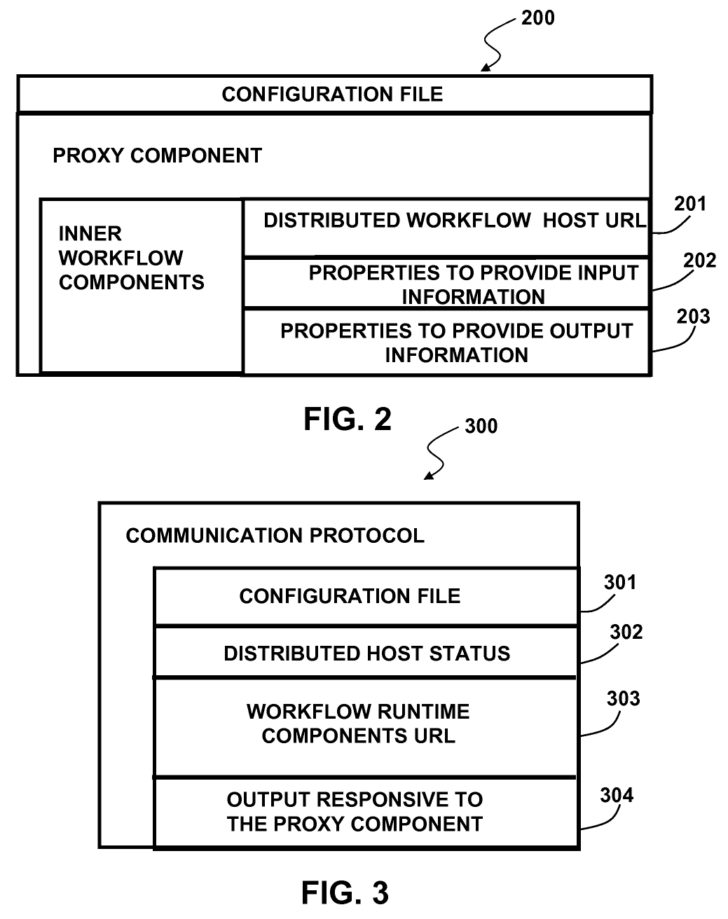

A distributed host program may include one or more workflow components as well as one or more proxy components. FIG. 2 illustrates an exemplary graphical depiction of the composition of some of the content of a configuration file proxy component 200. Each computing device participating in the distributed workflow may be identified via a network location, or unique Internet-accessible file address, such as a Uniform Resource Locator (URL). When preparing to execute a workflow, the computing device may bind workflow components according to a particular configuration file name. Accordingly, the proxy component is shown in FIG. 2 as having instructions for preparing distributed communication using, for example, the distributed workflow host URL 201 associated with a particular configuration file name. The intended recipient of the communication may be requested to execute one or more workflow components at particular states along the workflow process and would need to be effectively initialized for the appropriate workflow component steps for which execution is being requested. Accordingly, the proxy component is shown in FIG. 2 as having instructions for preparing distributed communication to a remote computing device; instructions that include properties and values for those properties appropriate for the workflow components for which execution is being requested 202. The computing device originating the distributed communication may require output values for particular properties in order to continue the overall workflow process and receives such output in order to effectively initialize the execution of subsequently invoked workflow components. Accordingly, the proxy component is shown in FIG. 2 as having instructions for preparing distributed communication that include properties and values for those properties appropriate for the one or more workflow components 203. Accordingly, output information may include results used at input for subsequent workflow components.

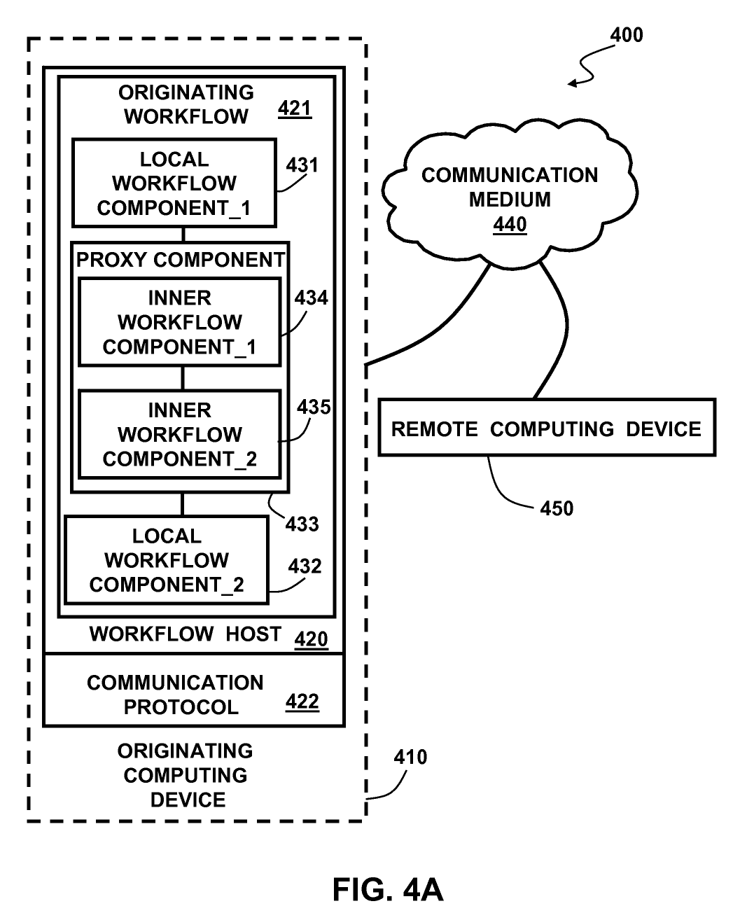

FIG. 3 illustrates an exemplary graphical depiction of the composition of some of the content according to a communication protocol 300 of the present invention. A remote, or distributed computing device, responsive to the communication protocol 300, receives information that identifies the configuration file in order to bind the appropriate workflow components with the proxy component and the originating computing device and receives information that may be correlated with the distributed communication. Accordingly, the communication protocol is shown in FIG. 3 as containing the configuration file name 301. The status of a particular distributed host 302 may be a part of the communication protocol in order to facilitate the originating device in the directing distributed processing to the least busy, least loaded, or most efficient processor of a plurality of candidate distributed processing devices. If one or more runtime elements or components, such as a member of a DLL, is not available as a runtime component for loading at the remote computing device, the communication protocol 300 may include the URL or other network address for the one or more workflow runtime components external to the remote computing devices 303 in order to facilitate the downloading and inclusion of the identified runtime components in the load phase at the remote computing device. In the communication from a distributed, or remote, computing device to the originating computing device, outputs necessary for subsequent portions of the overall workflow may be communicated according to the proxy component and the communication may include the network location of data generated by the one or more workflow components executed by the transmitting remote, or distributed, computing device. Accordingly, the communication protocol is shown in FIG. 3 as containing a portion responsive to the proxy component as output locations 304 for specifying properties, values of those properties and optionally network locations of data files.

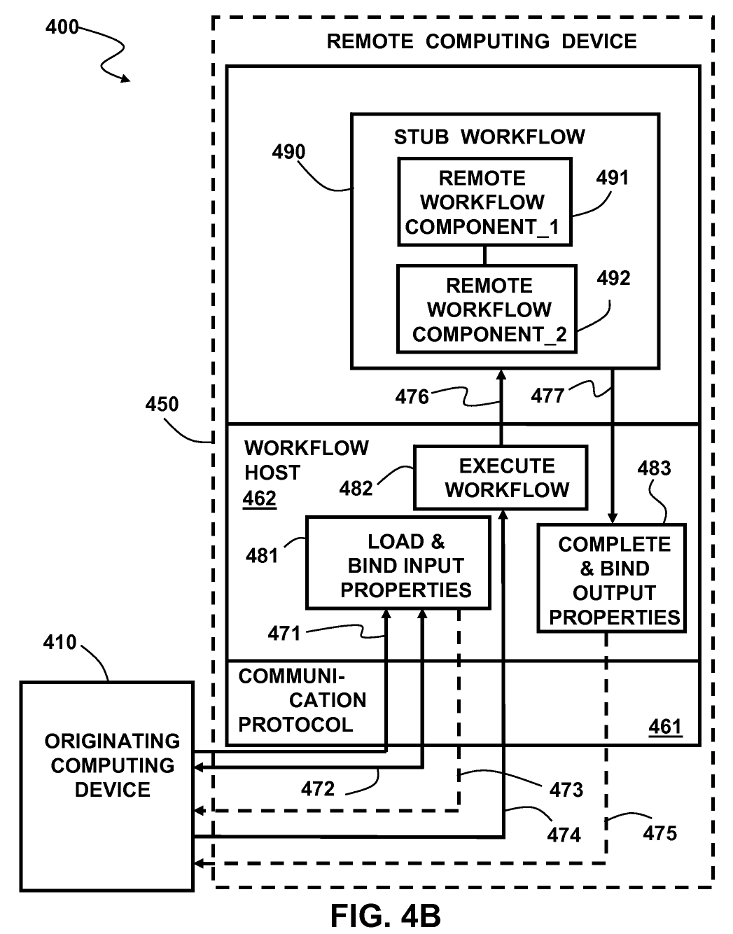

Illustrated in FIGS. 4A and 4B taken together is an exemplary system embodiment 400 of the present invention comprised of an originating computing machine or device 410 and a remote computing machine or device 450 in communication with one another via a communication medium 440 such as a network link, a local area network, or the internet The originating computing device 410 is shown if FIG. 4A has having a workflow host 420 and a communication protocol 422. The originating workflow 421 is shown having a proxy component 433, which may comprise one or more inner workflow components, interposed between a first local workflow component 431 and a second local workflow component 432. Accordingly, the proxy component 433 is shown as being comprised of a first inner workflow component 434 and a second inner workflow component 435.

The exemplary system 400 is again illustrated in FIG. 4B where details of an exemplary remote computing device 450 are shown and the communications between the remote computing device 450 and the originating computing device 410 are also shown having directional arrows and are understood to traverse a network link. The exemplary remote computing device 450 may comprise a workflow host 462, a communication protocol 461, and stub workflow 490 that may comprise one or more remote workflow components. In this example, the stub workflow is shown comprising a first workflow component 491 and a second workflow component 492 which respectfully may be exercised to effect the proxy components 434, 435 (FIG. 4A) of the originating computing device 410.

An exemplary operation may be illustrated via the signal paths of FIG. 4B where an initialization communication 471 may contain a configuration file that includes input for property values and, accordingly, the initialization communication 471 may be sent from the originating computing device 410 to the remote computing device 450. The workflow host 462 may then effect loading and binding 481 by the loading of runtime components and the binding of input values. If the loading requires one or more runtime components, such as a DLL, that are not available at the remote computing device 450, then the workflow host may request 472 of an external computing device, such as the originating computing device 410, one or more of the missing runtime components according to the communication protocol 461, and receive 472 via download, the requested one or more missing runtime components. Once a successful load and binding of input properties has taken place, a signal that initialization is complete 473 may be sent from the remote computing device 450 to the originating output device 410. The originating computing device 410 may next send an execution command 474 that when recognized by a workflow execution command 482, the workflow host 462 may invoke 476 the execution of the stub workflow 490, particularly the execution of the remote workflow components 491, 492. If the stub workflow 490 completes the steps of the invoked one or more remote workflow components 491, 492, the stub workflow 490 may signal 475 the workflow host 462 to bind the output properties 483 and communicate the completion of the execution 477 to the originating computing device 410.

Accordingly, a workflow host may be executed at each of two or more computing devices in a distributed workflow network where a workflow component, particularly a proxy component, is executed to invoke the distributed communication protocol over the network. A workflow component or a group of workflow components can be deployed on one or more computing machines as separated portions of the overall workflow. Each of these computing machines provides a workflow host program to host the distributed workflows. The workflow host program initiates the workflow through a predefined communication protocol (FIG. 3). Another exemplary communication protocol may specify: (1) the workflow to be executed, i.e., the configuration file; (2) values as input parameters to configure the distributed workflow components before executing the steps of the bound workflow components that represent the distributed workflow; and (3) values as output parameters for reception to let the originating workflow so that it may assign values to its bound component properties to continue the overall workflow as defined by the one or more bound workflow components that procedurally follow.

The originated workflow allows the input and output parameter to be bound to or from other workflow components. So, the information will be shared within the originated workflow as if all workflow components are hosted on the same machine. Accordingly, embodiments of the invention include processing devices that each have a workflow host that can communicate with other workflow hosts through a specific communication protocol (FIG. 3). Another exemplary communication protocol may include: (1) the distributed workflow to be executed that could be identified by a file name of the configuration file of the specified workflow where the distributed workflow host may load the distributed workflow components, i.e., the reusable modules of machine instruction, based on the configuration file; (2) input information that may comprise none or more binding items where each binding item further comprises a component name, property name, and property value and where the property values are preferably consistently arranged, e.g., serialized, so that they can be consistently read and manipulated across the machine, or process, boundary; and (3) output information that may comprise values for one or more properties of the distributed workflow components that may be bound, and may be executed by, the originating workflow host and originating computing device.

As to the distributed workflow host, a remote, or distributed, processing device may be adapted or configured to receive the input information, according to the communication protocol, and accordingly may assign values to none or more parameters within its local copy of the configuration. That is, in some embodiments, the remote, or distributed, workflow host will execute steps to set its workflow component property values based on the copied configuration before starting to execute its portion of the distributed workflow. As to property values to be returned to the originating device, embodiments of the invention have these output values formed according to the communication protocol so that the originated workflow host receiving this output information may respond by setting the values and continue executing workflow components subsequent to the proxy component 433 (FIG. 4A). As with the input property values, the output property values are preferably consistently arranged, e.g., serialized, so that they can be consistently read and manipulated across the machine, or process, boundary.

Since the exemplary embodiments have the originating computing device, particularly, the originating host program, missing at least one workflow component, the originating host program may execute a proxy component in place of the missing workflow components (FIG. 4A). That is, embodiments of the present invention provide a specific component that functions as the proxy of the distributed workflow component or the proxy of group of distributed workflow components. Thus, to a user observing input and final output at the originating computing device 410, the originating workflow may appear as if all its workflow components are or have been executed on the same machine and run in the same process, i.e., the originating machine and originating process.

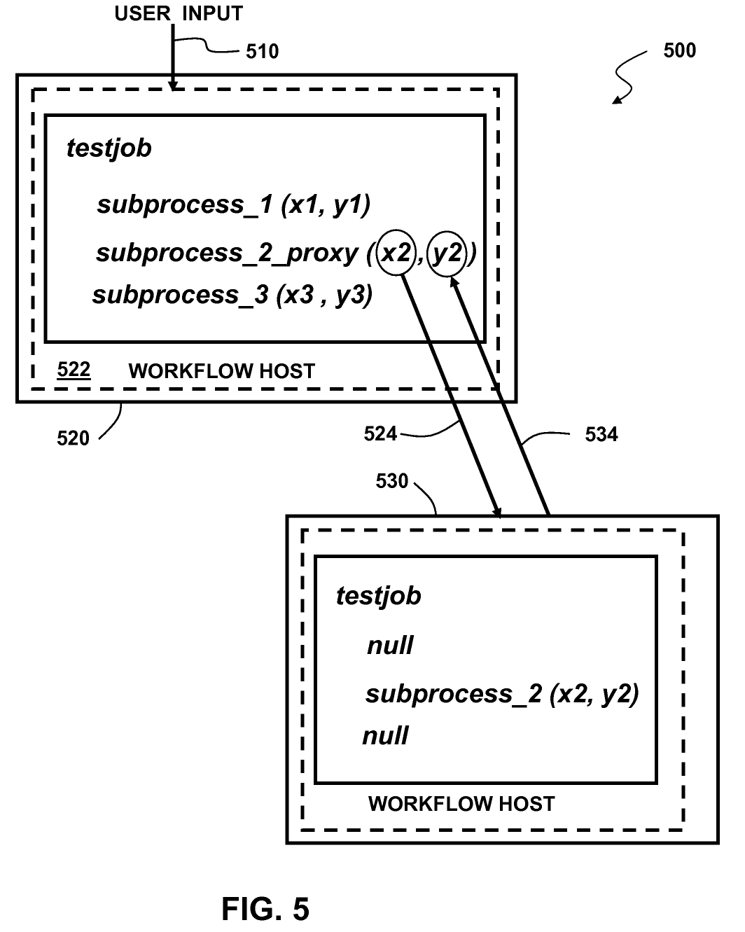

Referring to FIG. 5, user input 510 at a first computing machine 520 may invoke a configuration file, testjob, that cannot be executed exclusively by the first machine because a requisite workflow component, e.g., subprocess_2, is not present within the bounds of the first computing machine, particularly outside of the bound of the workflow host 522 being executed by the operating system of the first computing machine 520. Accordingly, testjob requires the binding of two local workflow components, e.g., subprocess_1 and subprocess_3 and a proxy component, e.g., subprocess_2_proxy. Once bound for runtime, the steps of subprocess_1 are executed, and then the steps of subprocess_2_proxy are executed that include transmitting a communication 524 according to the communication protocol to a second computing machine 530 having the workflow component subprocess_2 that may be bound as part of the local testjob and as may be identified within subprocess_2_proxy. The communication 524 includes the necessary inputs, generally represented as x2 for subprocess_2 that are available at the end of the first computing machine's execution of subprocess_1. Upon receipt of the communication by the second computing machine, subprocess_2 may be bound for runtime, its steps executed, and the output from the execution may be provided 534 to the first computing machine 520 where property values may be returned according to the communication protocol along with the network location of relatively large output data files.

The second computing machine 530 may respond to other communications having configuration files that require the binding of two or more local workflow components and/or combinations of one or more local workflow components and one or more workflow components not within the bound of the second computing machine, particularly the workflow host as executed by the machine's operating system. Accordingly, the second computing machine may be bound with one or more proxy components that allow for the chaining of additional computing machines and/or cycling of information between the first and second computing machines.

While the second computing machine 530 is handling the execution of the steps of subprocess_2, the first computing machine 520 may stand idle, e.g., be placed in a wait state, as to the particular workflow configuration file or may process subsequent workflow components not dependent on the output of the executed steps of subprocess_2. Accordingly, if subprocess_3 is a workflow component dependent on the output of execution of the steps subprocess_2, then the execution of testjob may be in a wait state until the first computing machine receives a communication from the second computing machine containing the requisite output as input for the execution of subprocess_3. Once the execution of the steps of subprocess_3 is complete, which may include retrieving data from a data file that may have been generated as part of the execution of the steps of subprocess_2, the workflow processing of testjob may be complete.

Based on the foregoing, it should be appreciated that systems, methods, and computer-readable media for executing workflow in a distributed network of computing devices are provided herein. One of ordinary skill in the art will also appreciate that the modules and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A computing device comprising:
a processing unit and addressable memory;
wherein the processing unit is configured to execute one or more instructions of a proxy workflow component based on a configuration file comprising a set of one or more property values.

2. The computing device of claim 1 wherein the processing unit is further configured to generate a communication for a second computing device, the communication comprising the configuration file name and a set of one or more property values for a workflow component related to the proxy workflow component.

3. A computing device comprising:
a processing unit and addressable memory;
wherein the processing unit is configured to execute one or more instructions of a workflow component based on an identified configuration file provided by a source and a set of one or more property values provided by the source and wherein the processing unit is further configured to generate, for the source, a set of results of workflow component instruction execution.

4. The computing device of claim 3 wherein the processing unit is further configured to generate the set of results as input for a proxy workflow component of the source.

5. A machine-enabled method of distributed workflow processing in a computer network comprising:
providing a proxy workflow component associated with a configuration file at a first computing node;
providing a workflow component associated with the configuration file at a second computing node;
preparing a transmission at the first computing node based on the proxy workflow component wherein the transmission comprises the configuration file name and a set of input values;
executing the workflow component with one or more members of the set of input values based on a receipt of the transmission from the first computing node; and
preparing a response to the transmission comprising the configuration file name and a set of output values based on the executed workflow component.

6. A computer-readable medium having computer-executable instructions stored thereon which, when executed by a computer, are operative to cause the computer to:
perform one or more instructions of a proxy workflow component based on a configuration file and a set of one or more property values; and
generate a communication for a second computing device, the communication comprising the configuration file name and a set of one or more property values for a workflow component related to the proxy workflow component.
